(19) United States
(12) Patent Application Publication
(10) Pub. No.: US 2025/0144557 A1
(43) Pub. Date: May 8, 2025

(54) CARBON CAPTURE COMPOSITION AND SYSTEM

(71) Applicant: Ramesh GOPALAN, Fremont, CA (US)

(72) Inventor: Ramesh GOPALAN, Fremont, CA (US)

(21) Appl. No.: 18/836,720

(22) PCT Filed: Feb. 20, 2023
(86) PCT No.: PCT/US2023/013436

§ 371 Date: Aug. 7, 2024

Related U.S. Application Data
(60) Provisional application No. 63/313,194, filed on Feb. 23, 2022.

(51) Int. Cl. B01D 53/14; B01D 53/62; B01J 20/26

(52) U.S. Cl. CPC B01D 53/1475; B01D 53/62; B01J 20/261; B01D 2252/10; B01D 2252/205; B01D 2252/504; B01D 2257/504; B01D 2258/01; B01D 2258/0233; B01D 2258/025; B01D 2258/0283; B01D 2258/06

(57) ABSTRACT

The invention is to a carbon capture composition to capture carbon dioxide from an input gas mixture. The carbon capture composition comprises water; an alkali carbonate; and a cross-linked superabsorbent polymer. Also disclosed is a carbon capture system including such carbon capture compositions. Such carbon capture systems are simple, requiring no moving parts, and constructed from existing materials and manufacturing methods, enable an economically sustainable low cost of carbon capture from industrial point sources, road transport vehicles or directly from atmospheric air.

### CROSS-REFERENCE TO RELATED APPLICATIONS

This application claims priority from provisional application 63/313,194 filed with the U.S. PTO on Feb. 23, 2022 by the same inventor Ramesh Gopalan.

### TECHNICAL FIELD

This invention pertains to compositions and systems to capture carbon dioxide from exhaust gases emitted from point sources such as power plants; industrial production of cement and steel; fossil-fueled motor vehicles and also to the direct air capture of carbon dioxide from the atmosphere.

### TECHNICAL PROBLEM and BACKGROUND ART

Given the slow reduction of global carbon emissions since the Paris 2015 agreement amongst almost 200 countries, and that fossil fuels still provide over 80% of the world's energy, the Intergovernmental Panel on Climate Change IPCC has begun insisting that carbon dioxide removal CDR from the atmosphere and from point sources will be necessary to avoid the worsening effects of climate change. The first modern scientific study into the scope and effect of carbon dioxide being released by industrial or power sources into the Earth's atmosphere by (Revelle & Suess, 1957) of the Scripps Institution of Oceanography, La Jolla, California, proposed that while carbonate ions in world's vast ocean waters would absorb the additional CO₂ the level of bicarbonate ions already in seawater would eventually limit this mitigating effect and the greenhouse gas would begin to accumulate in the atmosphere to levels that would cause a palpable rise in global temperatures. As established by the now well-known ‘Keeling Curve’ this atmospheric CO₂ level has exceeded 425 ppm in 2022—a 50% increase since the estimated 275 ppm before the Industrial Revolution began with the proclamation of James Watt's invention of the steam engine, ‘I sell here what all the world desires to have—Power’. Of course, all the fossil carbon has derived from plant life that existed even before the first dinosaurs walked the Earth. A point of perspective on carbon removal or utilization efforts which use the cultivation of biomass is that while plant-life—blue-green algae and phytoplankton—enabled the biggest carbon sink in our planet's history, transforming its >50% CO₂ early atmosphere into the oxygen-rich environment we find habitable today—this transformation took hundreds of millions of years: photosynthesis is a slow, natural process, as evident in the Keeling curve of CO₂ which shows an annual swing of only about 5 ppm from the spring-summer bloom of all the plant life across the planet. If man-made industrial processes have created the problem, it may follow that an artificial industrial scale process must provide the solution, at an economically sustainable cost.

As might be expected, it is less costly to capture and remove CO₂ from the exhaust or flue streams of industrial sources which, like common motor vehicles, are ˜10-20% CO₂ than from a dilute source such as the atmosphere at only 0.042% CO₂ (Wilcox, 2012). The cost of carbon capture and removal has been priced variously, depending on the source of emissions and national policies that still vary widely across the world. For example, the carbon emissions trading market in the European Union is estimated to be around US$900 billion in 2021, corresponding to a carbon price of around $90/tonCO₂ (The Economist, 2022). At CoP26 in Glasgow, Scotland, the U.S. Secretary of Energy proposed a 2030 cost target for carbon removal from industrial point sources to less than $100/tCO₂ (D.o.E, 2021).

Carbon capture from the input gas stream is the first and necessary step of carbon removal. The cost of the subsequent steps of compressing the CO₂ gas into liquid, transporting it by pipelines or trucks, followed by utilization or sequestration in geologic reservoirs (Herzog, 2018) means that the carbon capture step must cost a significantly smaller fraction of the total carbon removal cost of $100/tCO₂. Another point of perspective is provided here by noting that the cost of cheapest coal feeding thermal power plants is about $40/ton in 2022 and the burning of each ton of coal=carbon becomes nearly 3.7 tons of CO₂ gas emissions: this suggests that carbon capture from point sources must cost less than $30/ton to be economically sustainable.

Methods and systems to capture CO₂ have been deployed long before their increasing importance to the problem of addressing climate change. For example, various amine-based solvents have been used to remove CO₂ from natural gas; and lithium or other alkali hydroxides or zeolite-based modules have been used in space travel at least since the Apollo missions to the Moon. The key performance parameters of any carbon absorbent material are: uptake rate of CO₂; capture capacity per mass of absorbent; rate of unloading or desorption of the CO₂; and capacity fade rate or the (inverse of) the number of useful CO₂ uptake-unloading cycles before the absorbent material needs to be fully replaced. To advance these parameters various methods have been proposed to use materials containing alkali or alkali earth oxides or hydroxides to capture CO₂ by conversion to,for example, calcium carbonate (Carbon Engineering, 2015) (Kelemen, 2022); variations on the amine-based approach (Cansolv, 2009) (Gebald et al., 2010) (Carbon Clean, 2019) (Carbon Clean, 2021). Other variations have been proposed to include large porous structure, moving parts (Choi, 2013) (Eisenberger, 2019) and/or various molecular or metal-organic frameworks MOFs (Long, 2020) which typically include amine groups in structures that maximize the uptake of CO₂. Other current methods for carbon capture utilize specialized zeolites or molecular sieves such as (Reynolds, 2022). It is notable that as of end 2022, no method or system of carbon capture has yet publicly demonstrated the cost goals mentioned earlier.

The cost of carbon dioxide capture from a gas stream may be stated simply as the sum of:
a) Energy Cost: this is the cost of energy, typically heat, supplied to the carbon dioxide absorbent material to desorb the absorbed CO₂, and subsequently cooling it down to regenerate the absorbent for the next absorption-desorption cycle. The most obvious example of high energy costs are the ‘High Temperature or HT sorbent’ such as described in (Fasihi, et al., 2019). Any method where a key input to capturing carbon dioxide is an alkali or alkaline earth oxide or hydroxide must necessarily include the heat or energy cost of producing this from calcium carbonate-limestone-as raw material requiring temperatures as high as 900° C. and subsequently regenerating these sorbents by reversing the calcination. Other schemes to separate CO₂ such as using electrochemical means must also contend with the basic fact that CO₂ is a highly stable molecule and most chemical means of capturing and controllably releasing CO₂ must supply a significant amount of energy. Where renewable sources are used, it is still energy that could have been used to offset or avoid the more common, cheaper carbon-intensive sources of the same energy. Where pressure or vacuum swing adsorption-desorption is used, such as with zeolites or other molecular sieves which often have poor selectivity to CO₂ (vs. H₂O), the energy needed for dehydration of the input gas stream and to pressurize or pump out the absorbent presents substantial additional energy costs.
b) Material cost: Where the absorbent is regenerated at modest temperatures, with small heat input, the largest cost contribution is that of the absorbent material divided by the total weight of carbon dioxide that it is capable of capturing over multiple absorption-desorption cycles.

For instance, consider a CO₂ absorbent costing $2000/ton that captures 100 kg of CO₂ per ton per absorption-desorption cycle. If the capture capacity of this absorbent is significantly degraded in, say, 100 regeneration cycles, then the material cost of the corresponding carbon capture method is $2000/(0.1 ton*100)=$200/tonCO₂.

Material cost remains a challenge for what is currently the most common approach to carbon capture—using aqueous solutions or solvents including amines, for example, monoethanolamine MEA, diethanolamine DEA—or other structures including similar amino-polymers. Aspects of the chemistry of amines are unavoidable—they are toxic to the human environment; corrosive to metal components of the carbon capture system and perhaps most significantly subject to degradation by oxidation, water vapor and (hydro) thermal degradation by steam at temperatures above 100° C. which, unavoidably, is overlapping the temperature range for stripping the absorbed CO₂ and regenerating the solvent for the next absorption-desorption cycles (Davis et al, 2009) (Zoannou et al, 2013). Where multi-component chemistries are used, such as involving hindered amines or buffers, the higher complexity generally does not enable lowered costs. Since oxygen and water vapor are inevitable components of exhaust or flue gas streams this degradation presents a substantial limitation on the cost scalability of these approaches for carbon capture.
c) Operational & other costs: Another significant component of cost maybe described as operational or manufacturing cost, such as incurred to maximize uptake of CO₂ onto the solvent or sorbent and removal of the heat of absorption. Examples of these are where large rotating cylinders—moving parts which need constant and costly maintenance—or complex molecular frameworks such as MOFs which are being proposed to enable high surface area for CO₂ uptake and management of the heat of absorption of the carbon capture reaction.

### SUMMARY OF THE INVENTION

The present invention is to a carbon capture composition that comprises a mixture of an aqueous solution of an alkali carbonate and a cross-linked superabsorbent polymer. The carbon capture composition requires low heat energy input and only moderately elevated temperatures for regeneration. It has a low capacity fade rate over multiple regeneration. Also disclosed is a carbon capture system that is simple, easy to manufacture, and operate.

### Solution to the Problem

As already mentioned, the world's largest sinks of carbon dioxide are the vast oceans where CO₂ dissolves into sea water reacting with carbonate ions to form bicarbonates. The chemistry is simple: alkali carbonates, like sodium carbonate, in water, absorb CO₂ in an exothermic reaction:

Na₂CO₃+H₂O+CO₂→2NaHCO₃ Equation 1:

As (Revelle & Suess, 1957) pointed out, however, this powerful natural process has become inadequate to remove the 40 billion tons of CO₂ being dumped into the atmosphere by global human activity. As discussed in (NETL, 2015, pp. 27, 54) even as alkali carbonates have lower heat of regeneration than amines, their use for carbon capture on an artificial or industrial scale has thus far been hindered by their low diffusion and reaction rates in aqueous solutions, and by process bottlenecks of heat removal and management in (hydrated) solid sorbents.

Unlike other carbon absorbing chemicals, sodium carbonate—‘washing soda’—and potassium carbonate—an ingredient of ‘potash’ are already produced at low cost and vast industrial scales. [Indeed, the first United States Patent, in 1790, was for a method of manufacturing potash.] Sodium and potassium carbonates are also highly stable to very high temperatures and unaffected by the oxidative or thermal degradation that eventually undermines amine-based chemistries. Worldwide production in 2022 of such carbonates is over 50 million tons each with prices ranging $300-1000/ton.

Promising proof of concepts to address the problem of slow uptake of CO₂ and heat removal including (Vericella, et al., 2015) and (Cai, 2018) by making silicone microencapsulated alkali carbonate aqueous solutions or having free flowing hydrated sodium carbonate powders have demonstrated that increasing the effective the CO₂-absorbent interface surface area can increase the CO₂ capture rate and capacity, but do not yet present practicable solutions for large scale carbon capture.

The present invention is to utilize Nature's own process of carbon capture into water solutions of alkali carbonates, albeit modified to speed up the diffusion and reaction rates of CO₂ and to optimize the management of heat of absorption (and desorption or unloading) of the captured CO₂.

This is enabled by added the simple mixture or aqueous solution of water and an alkali carbonate to a superabsorbent polymer.

Superabsorbent polymers are a well-known class of materials which act as a ‘water-lock’ by absorbing up to 10-1000x their weight in water or aqueous solutions. Their most common application is in personal hygiene products but have also been included in many other common consumer use items from detergents to food items. There are many such superabsorbent polymers—SAPs, (Wikipedia, 2023) but the most common is sodium polyacrylate SPA—a polymer formed from sodium acrylate C₃H₃NaO₂ monomer produced as the ionic salt combination of sodium hydroxide and acrylic acid. The SAPs are typically cross-linked, to reduce their solubility in water so as to form very large yet porous networks to enhance their absorption rate and capacity. (P&G, 1981), for example, discloses an absorbent composition comprising ‘a copolymer of acrylic acid with a first cross-linking component comprising a monomer having at least two vinyl groups and second cross-linking component comprising an ionic divalent cation.’ There are many subsequent versions of cross-linked SPA, tuned to the properties of the functions of the intended final product:absorbents for human personal use; artificial ‘snow’ for entertainment and decoration; absorbents for industrial or environmental waste management; and water conserving products for agriculture and horticulture are just some of the expamples that use sodium polyacrylate with a world wide production of over 5 million tons at a wholesale price of $1000-2000/ton in 2022. There are many suppliers of cross-linked versions of sodium polyacrylate or acrylamide co-polymers, costing $2000-10000/ton, again depending on the specialization of the absorbing properties for the intended application.

The cross-linked sodium polyacrylate ‘super-absorbent’ of water solutions works by the H⁺ ions of water replacing the Na⁺ in the backbone of the SPA polymer. The additional water and dissolved carbonate ions attaches through hydrogen bonds to the mesh or net like structure formed by the cross-linked polymer chains in phenomenon that is similar to osmosis through a permeable membrane. The exact compositions and methods of manufacture modifying SPA to render it cross-linked are often trade secrets, but the cross-linker density in the SPA typically comprises less than a few % by weight. Examples of cross-linkers or cross-linking agents used are: Trimethylolpropane triacrylate TMPTA; Ethylene glycol dimethacrylate EGDMA; Methylene bis-acrylamide; Allyl methacrylate; tetraallyl ethoxy ethane and their related chemical groups or precursors.

Although all SAPs or cross-linked sodium polyacrylate versions are capable of the ‘water-lock’ function, absorbing many times their weight of water solutions. In our testing, we have the addition of even around 5-10% by wt of some commonly produced versions of cross-linked SPA to highly concentrated aqueous solutions of alkali carbonates creates the highly porous, powdery, ‘fluidizable’ sponge-like sorbent materials that feels and acts dry even as it is ˜80% a water solution. The porosity enables the rapid diffusion of CO₂-containing gas mixtures through this porous structure, and the very high surface area allows a rapid reaction rate, with easy transfer of the heat of absorption/desorption to the gas mixture that flows through easily.

In one embodiment of the invention, sodium carbonate and water are combined in a weight ratio around 1:4 which is similar to the solubility in aqueous solution at 25° C. To this mixture was added an ‘snow’ version of cross-linked sodium polyacrylate, which increased the volume of the total mixture by 1.5-2×, resulting in a porous, fluidizable, powdery, sponge-like sorbent with average particle size about 0.5-1 mm. It appears that the size of these particles is determined by the nature of the cross-linking of the sodium polyacrylate polymer chains. In any case, the result is that these clusters of mostly water and alkali carbonate present a very high effective surface area for the diffusion of gas (including CO₂) into the reaction sites, and also enable easy heat transfer from a highly porous framework of carbon capture sites with a density of around ˜0.6grams/cc that is not significantly less that of water.

Using various ratios of alkali carbonate: water: superabsorbent polymer we have demonstrated a CO₂ capture capacities of 1-3mmol/gram of sorbent occurring over 7-12 minutes when exposed to near pure CO₂. The absorption rate i.e. gCO₂/g-sorbent·minute did not appear to reduce significantly with reducing the partial pressure of CO₂ by diluting with nitrogen gas. This performance is comparable with other methods materials currently being used for carbon capture, a and may be further optimized for uptake rate, capacity and energy required for desorption. The additional advantage of the present invention is that it needs very little heat energy to desorb or unload the absorbed CO₂. The sorbent compositions that include sodium carbonate in water solutions, for example, absorb CO₂ readily at temperatures below 50° C. and release CO₂ gas just as readily upon heating to 80-90° C., at or near 1 atmosphere=100 kPa pressure, for about 10 minutes.

Thus the sorbent is regenerated easily at temperatures below the reported decomposition temperatures of solid sodium or potassium bicarbonate, possibly because the open network of molecules in the sorbent increases the reverse reaction rate of Equation 1 at lower temperatures than solid or liquid solvent for e.g. (Miroslav Hartman, 2019). The regeneration is also observed to occur below the boiling point of water, and although there is inevitably some water loss through evaporation at the elevated temperature this is easily replenished as the ‘water-lock’ property of the super-absorbent polymer tends to conserve moisture. And so we have a very low energy cost of capturing and unloading CO₂, allowing the possibility of utilizing low-grade or waste heat that are usually present from the point sources of CO₂ emission such as power plants or even the internal combustion engines of most transportation vehicles. Also significant, the regeneration temperature is much less than the degradation temperature of any of the components of the carbon capture material, specifically the alkali carbonates—stable to ˜800° C., it should be clear that the superabsorbent polymer does not participate in the CO₂ absorption desorption reaction and is unaffected by the carbon capture and unloading process. The sodium (poly) acrylate (McNeill, 1990) as well as the cross-linking bonds are also highly stable at the typical temperatures required for regeneration. We have found no measurable degradation in carbon capture performance, or capacity fade, after exposing the sorbent material to (heat*time) equivalent of 100 carbon capture cycles. Since this sorbent is manifestly unaffected by the oxidation or hydrothermal degradation that affect other current carbon capture materials, it enables many more CO₂ absorption-unloading or regeneration cycles, and therefore promising of a low carbon capture material cost.

Although sodium carbonate solution appears to require the lowest heat and temperature for regeneration, mixtures of potassium carbonate solution ands super-absorbent polymers appears to provide a higher saturation capacity of CO₂ capture, even if also requiring higher temperatures and heats of desorption. This approach—of using an aqueous solution in a gel framework with a super-absorbent polymer—will clearly work as well with other well known chemistries that react with carbon dioxide and water, including the amines such as methanolamine, or diethanolamine used in current methods of carbon capture. In summary, this simple mixture of commonly available, highly stable, non-toxic, non-corrosive materials enables the same carbon capture efficiency and capacity of previously mentioned molecular frameworks or microencapsulations, albeit at much lower manufacturing complexity and cost.

We have so far described a composition that enables capture of carbon dioxide from an input gas stream. We may further describe a system or apparatus utilizing such compositions that could capture CO₂ from such a stream and then controllably release or unload the CO₂ for compression, transport and eventual utilization or sequestration. As schematic for such a system is shown in FIG. 1, depicting two carbon capture modules containing the carbon capture composition we have so far described. These two modules could operate in tandem—while one of the two module—the absorption phase capturing CO₂ from the input gas stream—is cooled with water to below 40° C. the other—desorption phase releasing the captured CO₂—is in a bath with water heated to above 80° C. When each phase, of approximately equal time duration, concludes, the appropriate valves will open/close; the cold/hot water flows reversed and the modules will alternate roles, switch between the absorption/desorption phases, thereby enabling continuously operating carbon capture.

This carbon capture composition may be used to capture CO₂ from any gas stream, irrespective of the starting concentration. In particular, we have demonstrated direct air capture DAC with less than 10 g of the carbon capture composition described earlier reducing the CO₂ concentration from an enclosed volume of 10 liters starting from 423 ppm to the (pre-Industrial) level of 284 ppm. Of course, the higher the concentration of CO₂, the more economical the capture process. The CO₂ content of exhaust from cement or steel plants, power plants as as common internal combustion engine ICE powered motor vehicles all have CO₂ content in the range of 10-20%. It should also be clear from the preceding description of the invention that it may be utilized to capture any water soluble gas—including acid gases such as SOx, NOx, H₂S and CL₂—with a capture composition that comprises water; a substance capable of chemical combination with the water soluble gas and water; and a superabsorbent polymer.

The carbon capture system described earlier is manifestly scalable—weights/volumes/areas of the carbon capture layer—to capture carbon dioxide from ICE automobiles emitting <100 kgCO₂/day to large industrial point sources emitting >1 million tonsCO₂/year. It is also pertinent to note here that while transport accounts for the large part of U.S. and global carbon footprint, the reduction of such emissions is slow because the electric battery is a significant cost and weight burden on the current zero-carbon or electric vehicles EVs. Through the deployment of mobile carbon capture systems comprising the described carbon capture compositions it may be feasible to convert common fossil-carbon fueled road transport vehicles into zero-emission vehicles, at lower cost and weight than comparable EVs available today.

### DESCRIPTION OF THE DRAWINGS

FIG. 1 is a schematic of an embodiment of the carbon capture system including the carbon capture composition in two symmetric carbon capture modules, operating in tandem: the absorption phase module is exposed to an CO₂ containing input gas mixture while in a cool water bath; the desorption phase module is heated in a hot water bath, releasing the absorbed CO₂ for further processing (compression, transport, utilization or sequestration).

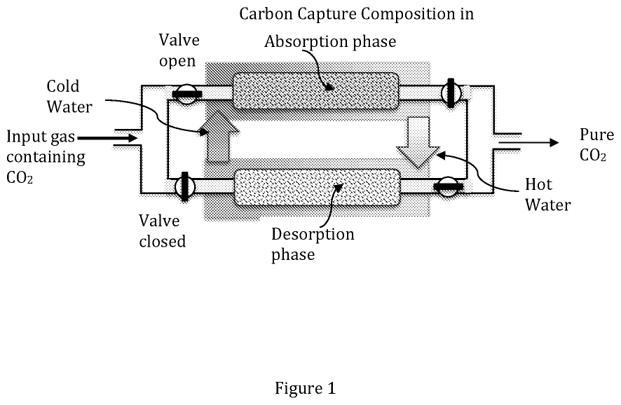

The absorption and desorption phases will alternate roles while the valves open/close and the water heating/cooling circulation cycle reverses flow accordingly. Not shown in the schematic are means for exhausting the CO₂-free gas and means for chilling/heating the water, which may be part of the existing heat exchanger of the industrial or transport process.

### PATENT REFERENCES

Cansolv, O. e. a., 2009. Process for recovery of carbon dioxide from a gas stream. U.S. Pat. No. 7,601,315.
Carbon Clean, B. P., 2021. Solvent Composition for Carbon Dioxide Recovery. European Patent Office, Patent No. EP 2618914.
Carbon Clean, B. P. e. a., 2019. Carbon Capture solvents and methods of using such solvents. U.S. Pat. No. 10,239,014.
Carbon Engineering, K. D. e. a., 2015. Carbon Capture Method and Facility. U.S. Pat. No. 9,095,81.
Choi, S. e. a., 2013. U.S. Pat. No. 8,491,705.
Eisenberger, P. & Chichilnisky, G., 2017. U.S. Pat. No. 9,616,378.
Eisenberger, P. e. a., 2019. Rotating multi-monolith bed movement system for removing CO₂ from the atmosphere. U.S. Pat. No. 10,512,880.
Gebald et al., 2010. Amine containing fibrous structure for adsoprtion of CO₂ from atmospheric air. European Patent Office, Patent No. WO 2010/091831 PCT/EP2010/000759.
Kelemen, P. B. e. a., 2022. Systems and Methods for Enhanced Weathering and Calcining for CO₂ removal from air. PCT/US, Patent No. WO 2022/187336 PCT/US2022/018484.
Long, J. e. a., 2020. Cooperative chemical adsorption of acid gases in functionalized metal-organic frameworks. U.S. Pat. No. 10,722,863.
P&G, P., 1981. Cross-linked sodium polyacrylate absorbent. U.S. Pat. No. 4,295,987.
Reynolds, C. e. a., 2022. System and method for mobile carbon capture. United States of America, Patent No. US 2022/0282651.
U.S. Pat. No. 11,117,091, 2021. Separation of a target substance from a fluid or mixture using encapsulated sorbents. United States of America, U.S. Pat. No. 11,117,091.

### NON-PATENT REFERENCES

Cai, Y. e. a., 2018. Effective Capture of Carbon Dioxide Using Hydrated Sodium Carbonate Powders. Materials, pp. 183-193.
Christopher A. Trickett, A. H. B. A. A.-M. Z. H. Y. K. E. C. &. O. M. Y., 2017. The chemistry of metal-organic frameworks for CO₂ capture, regeneration and conversion. Nature Reviews Materials, 2(17045).
D.o.E, U., 2021. Negative Earth Shot. [Online] Available at: https://www.energy.gov/articles/secretary-granholm-launches-carbon-negative-earthshots-remove-gigatons-carbon-pollution
Davis et al, J., 2009. Thermal degradation of monoethanolamine at stripper conditions. Energy Procedia, Volume 1, pp. 327-333.
Fasihi, M., Efimova, O. & Breyer, C., 2019. Techno-economic assessment of CO₂ direct air capture plants. Journal of Cleaner Production, pp. 957-980.

### Herzog, H., 2018. Carbon Capture. s.l.: MIT Press.

McNeill, I. C. &. S. S., 1990. Thermal stability and degradation mechanisms of poly(acrylic acid) and its salts: Part 2—Sodium and potassium salts. Polymer Degradation and Stability, 30(2), pp. 213-230.
Miroslav Hartman, K. S. e. a., 2019. Decomposition of Potassium Hydrogen Carbonate: Thermochemistry, Kinetics, and Textural Changes in Solids. Ind. Eng. Chem. Res, 58(8), pp. 2868-2881.
NETL, U. D. o. E. -., 2015. Carbon Capture Handbook. [Online] Available at: https://netl.doe.gov/sites/default/files/netl-file/Carbon-Dioxide-Capture-Handbook-2015. pdf [Accessed 2022].
Revelle, R. & Suess, H., 1957. Carbon Dioxide Exchange between Atmosphere and Ocean and the Question of an Increase of Atmospheric CO₂ during the past decades. Tellus, pp. 18-27.

### The Economist, 2022. The Economist, May.

Vericella, J. J., Baker, S. E., Stolaroff, J. K. & al, e., 2015. Encapsulated liquid sorbents for carbon dioxide capture. Nature Communications.
Wikipedia, 2023. Superabsorbent polymer. [Online] Available at: https://en.wikipedia.org/wiki/Superabsorbent_polymer [Accessed 2023].

### Wilcox, J., 2012. Carbon Capture. s.l.: Springer.

Zoannou et al, K.-S., 2013. Thermal degradation of monoethanolamine and its effect on CO₂ cpature capacity. International Journal of Greenhouse gas control, Volume 17, pp. 423-430.

1-20. (canceled)

20. A system configured to capture carbon dioxide from an input gas mixture comprising carbon dioxide, said system further comprising:
a carbon capture composition comprising water, a superabsorbent polymer, and a carbon capture substance selected to chemically combine with said carbon dioxide and said water;
said superabsorbent polymer selected to be capable of absorbing 10-1000x its weight in any of said water or an aqueous solution.

21. The system of claim 20, wherein said superabsorbent polymer comprises sodium polyacrylate.

22. The system of claim 20, wherein said carbon capture substance comprises sodium carbonate.

23. The system of claim 20, wherein said carbon capture substance comprises potassium carbonate.

24. The system of claim 20, wherein said superabsorbent polymer further comprises cross-linked polymer chains cross linked by a chemical cross-linker molecule.

25. The system of claim 24, wherein said chemical cross-linker molecule is selected from the group consisting of Trimethylolpropane triacrylate (TMPTA), Ethylene glycol dimethacrylate (EGDMA), Methylene bis-acrylamide, Allyl methacrylate, and tetraallyl ethoxy ethane.

26. The system of claim 24, wherein said chemical cross-linker molecule comprises less than 5% of total weight of said superabsorbent polymer.

27. The system of claim 20, wherein said carbon capture substance comprises an amine group.

28. The system of claim 27, wherein said carbon capture substance comprises monoethanolamine.

29. The system of claim 20, said system further configured with at least one alternating phase module containing said carbon capture composition, said system further comprising:
a cooling mechanism to cool at least one said alternating phase module to a temperature below 50° C., thereby producing at least one absorption phase module;
a valve configured to expose at least one said absorption phase module to said input gas mixture, thus enabling at least one said absorption phase module to absorb said carbon dioxide;
a heating mechanism to heat at least one said absorption phase module to a temperature above 80° C., thereby converting at least one said absorption phase module into at least one desorption phase module; and
a valve configured to enable any previously absorbed carbon dioxide, now released from said carbon capture composition, to exit at least one said desorption phase module.

30. A composition to capture a water soluble gas from an input gas mixture comprising water;
a substance capable of chemical combination with the water soluble gas and water;
a superabsorbent polymer.

31. The system of claim 29, wherein said system is further configured to capture carbon dioxide from any of:
flue gas of power plants;
emissions of industrial processing of any of cement, steel or petroleum; exhaust of motor vehicles;
or directly from atmospheric air.

32. The system of claim 22, wherein said carbon capture composition further comprises sodium carbonate and water in a weight ratio of about 1:4, said superabsorbent polymer comprises sodium polyacrylate comprising a weight percent of 5 to 10 percent of said carbon capture composition, and wherein said superabsorbent polymer further comprises less than 5% cross linker by weight percent.

33. The system of claim 20,
wherein said superabsorbent polymer comprises sodium polyacrylate;
wherein superabsorbent polymer further comprises cross-linked polymer chains; and
wherein said carbon capture substance comprises any of an alkali carbonate or a substance comprising an amine group.

34. A system configured to capture carbon dioxide from an input gas mixture comprising carbon dioxide, said system further comprising:
a carbon capture composition comprising water, a superabsorbent polymer, and a carbon capture substance selected to chemically combine with said carbon dioxide and said water;
wherein said superabsorbent polymer comprises sodium polyacrylate;
wherein superabsorbent polymer further comprises cross-linked polymer chains; and
wherein said carbon capture substance comprises any of an alkali carbonate or a substance comprising an amine group;
said system further configured with at least one alternating phase module containing said carbon capture composition, said system further comprising:
a cooling mechanism to cool at least one said alternating phase module to a temperature below 50° C., thereby producing at least one absorption phase module;
a valve configured to expose at least one said absorption phase module to said input gas mixture, thus enabling at least one said absorption phase module to absorb said carbon dioxide.
